(19) United States
(12) Patent Application Publication
(10) Pub. No.: US 2018/0048677 A1
(43) Pub. Date: Feb. 15, 2018

(54) Inmate Correspondence Systems and Methods

(71) Applicant: Marc A Grisham, Frisco, TX (US)

(72) Inventor: Marc A Grisham, Frisco, TX (US)

(21) Appl. No.: 15/658,301

(22) Filed: Jul. 24, 2017

Related U.S. Application Data
(60) Provisional application No. 62/366,456, filed on Jul. 25, 2016.

(51) Int. Cl. H04L 29/06; H04N 1/32; H04N 1/00; G06F 3/12

(52) U.S. Cl. CPC H04L 63/306; G06F 3/126; G06F 3/1203; G06F 3/1288; H04N 1/32128; H04N 1/00413; H04N 2201/3207; H04N 2201/0082

(57) ABSTRACT

In some embodiments, a system may be configured to receive correspondence data including an address associated with an inmate. The system may determine correspondence rules corresponding to the address and may verify compliance of the correspondence data with the correspondence rules before producing a package to be mailed to the inmate. When the correspondence data does not comply, the system may communicate with the sender to receive corrected correspondence data or may automatically adjust the correspondence data to comply with the correspondence rules.

### CROSS-REFERENCE TO RELATED APPLICATION(S)

This application is a non-provisional of and claims priority to U.S. Provisional Patent Application No. 62/236,456 filed on Jul. 25, 2016 and entitled “Inmate Correspondence Systems and Methods”, which is incorporated herein by reference in its entirety.

### FIELD

The present disclosure is generally related to inmate picture delivery systems and methods, and more particularly, to systems and methods of facilitating delivery of correspondence, including pictures, to inmates housed in correctional facilities.

### BACKGROUND

Sending mail to an inmate in a correctional facility can present a number of challenges. First, correction authorities frequently transfer inmates between correction facilities, such as from a jail (where one is held prior to conviction) to a prison (where one is held after conviction). Such transfers sometimes occur on short notice and can interfere with inmate mail delivery, causing correspondence from friends and family members to become lost.

Further, different incarceration facilities can have different rules regarding inmate correspondence. For example, since correction authorities inspect and read incoming mail, incarceration facilities often impose page limits on incoming mail, which page limits can include pictures or other attachments in the page count. Such page limits may vary from facility to facility, and delivery may be delayed or prevented based on the failure of the sender to comply with the particular mail rules of the incarceration facility. Additionally, some incarceration facilities may have rules regarding inclusion of attachments, such as photographs or documents. One facility may ban Polaroid photographs, while another may allow them. Still other facilities may limit the size of attachments in terms of memory usage (e.g., file size), which can present an obstacle to delivery. As a result, the correspondence rules can be difficult for family members to navigate.

### SUMMARY

In some embodiments, a system may be configured to receive correspondence data including an address associated with an inmate. The system may determine correspondence rules corresponding to the address and may verify compliance of the correspondence data with the correspondence rules before producing a package to be mailed to the inmate. When the correspondence data does not comply, the system may communicate with the sender to receive corrected correspondence data or may automatically adjust the correspondence data to comply with the correspondence rules.

In other embodiments, the system may automatically adjust the correspondence data to comply with the rules by adjusting the margins, adjusting the font size, removing non-compliant content (such as images that do not comply with the correspondence rules), or otherwise adjusting the content. In some embodiments, the system may alert the user to the non-compliance to enable the user to make adjustments or authorize the system to make adjustments to the correspondence data to bring it into compliance for mailing.

In still other embodiments, the system may be configured to split the correspondence into two or more packets so that the mailed packets may comply with page limits or other size restrictions. Further, the system may be configured to make recommendations or flag potential issues before the user submits the correspondence. Other embodiments are also possible.

In some embodiments, a computing device can include a network interface configured to communicate with a network, a processor coupled to the network interface, a printer coupled to the processor, and a memory coupled to the processor. The memory may be configured to store instructions that, when executed, cause the processor to receive correspondence data from a computing device through the network. The instructions may further cause the processor to determine correspondence rules corresponding to the incarceration facility from a plurality of correspondence rules based on an address associated with the correspondence data and to process the correspondence data to determine compliance with the correspondence rules. The instructions may also cause the processor to control the printer to produce a physical copy of the correspondence data for mailing to an inmate of a correctional facility when the correspondence data complies with the correspondence rules associated with the address.

In still other embodiments, a method may include receiving, at a computing device, correspondence data for sending to an inmate of a correctional facility. The method may further include automatically determining, at the computing device, correspondence rules associated with the correctional facility from a database including a plurality of compliance rules. The method may also include automatically processing, at the computing device, the correspondence data to determine compliance with the correspondence rules. Further, the method may include automatically providing the correspondence data to a printing device to produce a physical copy of the correspondence data when the correspondence data complies.

### BRIEF DESCRIPTION OF THE DRAWINGS

FIG. 1 depicts a block diagram of an inmate correspondence system, in accordance with certain embodiments of the present disclosure.

FIG. 2 illustrates a block diagram of an inmate correspondence system, in accordance with certain embodiments of the present disclosure.

FIG. 3 depicts a flow diagram of a method of producing correspondence addressed to an inmate, in accordance with certain embodiments of the present disclosure.

FIG. 4 depicts a flow diagram of a method of processing a package to produce correspondence addressed to an inmate, in accordance with certain embodiments of the present disclosure.

FIG. 5 depicts a flow diagram of a method of selectively adjusting correspondence addressed to an inmate to comply with rules of an incarceration facility, in accordance with certain embodiments of the present disclosure.

FIG. 6 illustrates a flow diagram of a method of forwarding returned correspondence to a new address associated with the inmate, in accordance with certain embodiments of the present disclosure.

FIG. 7 depicts an interface through which a user may interact with the inmate correspondence system to send correspondence to a selected inmate, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

In the following detailed description of the embodiments, reference is made to the accompanying drawings which form a part hereof, and in which are shown by way of examples. The features of the various embodiments and examples described herein may be combined, exchanged, removed, other embodiments utilized, and structural changes made without departing from the scope of the present disclosure.

One or more aspects or features of the subject matter described herein can be implemented in digital electronic circuitry, integrated circuitry, application specific integrated circuits (ASICs), field programmable gate arrays (FPGAs), another dedicated hardware implementation, computer hardware, firmware, software, or any combination thereof. In accordance with various embodiments, the methods and functions described herein may be implemented as one or more software programs or instructions executable by a computer processor of a computing device, such as a laptop computer, a server, a desktop computer, or a handheld computing device, such as a tablet computer, a personal digital assistant (PDA), or smart phone. Further, in some embodiments, the methods and functions described herein may be implemented as a device, such as a non-volatile computer readable storage device or memory device, including instructions that, when executed, cause a processor to perform the methods and functions.

Embodiments of systems and methods are described below that may be configured to facilitate correspondence between an individual outside of jail or prison and an inmate within the jail or prison system. In some embodiments, a system may include a processor configured to receive correspondence from a user, to determine an address associated with the correspondence, and to verify the correspondence against correspondence rules associated with a facility corresponding to the address. When the correspondence satisfies the correspondence rules, the system may automatically produce the correspondence and send the correspondence to the address.

In some embodiments, when the correspondence fails to satisfy the correspondence rules, the system may alert the user regarding any non-compliance issues (such as page count, file size, or other non-compliance issues) to allow the user to correct the issue and resubmit. Alternatively, when the correspondence fails to satisfy the correspondence rules, the system may automatically suggest changes to bring the correspondence into compliance. In some embodiments, the system may selectively alter the correspondence, such as by adjusting the margins, adjusting the font, adjusting the line spacing, dividing the correspondence into two separate packages, making other adjustments, or any combination thereof in order to produce a correspondence package that satisfies the correspondence rules and that can be mailed to the inmate via the United States Postal Service (or emailed via an electronic correspondences system). In an example, the system may automatically print the correspondence and the attachments and may automatically package the correspondence for mailing to the inmate in accordance with the correspondence rules. Other embodiments are also possible.

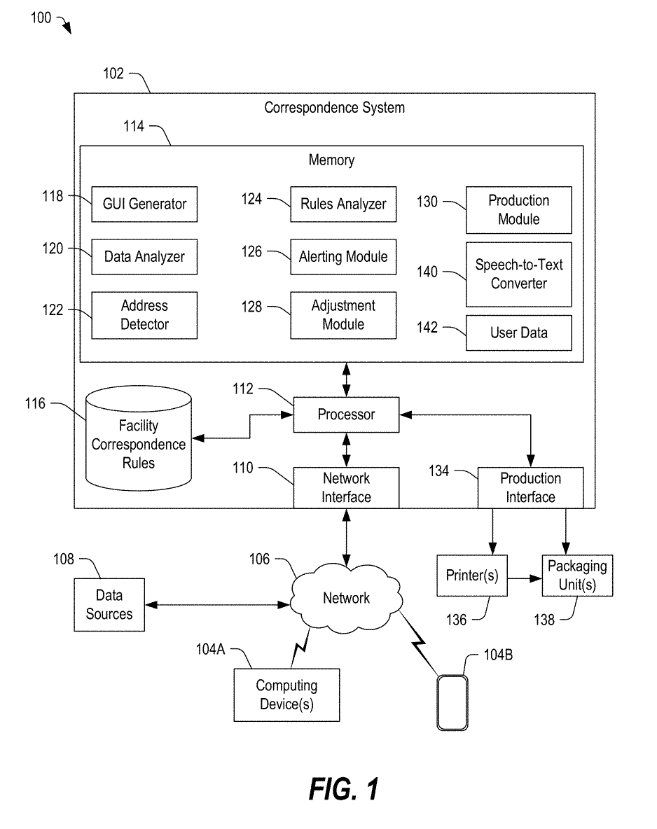

FIG. 1 depicts a block diagram of an inmate correspondence system 100, in accordance with certain embodiments of the present disclosure. The system 100 may include a correspondence system 102 configured to communicate through a network 106 with one or more computing devices 104. The computing devices 104 can include laptop computers, tablet computers, desktop computers, other data processing devices, and the like (generally designated as 104A). The computing devices 104 may also include communication devices, such as smart phones (generally designated as 104B), cellular phones, landline phones, or other communication devices capable of sending and receiving data. The network 106 can include a public switched telephone network, a communications network (digital, cellular, or satellite), as well as a data network (such as a local area network, a wide area network, the Internet, or any combination thereof). The correspondence system 102 may also communicate with one or more data sources 108, such as websites or databases, to retrieve correspondence rules for a particular facility.

The correspondence system 102 may also be coupled to one or more printers 136 and to one or more packaging units 138. In some embodiments, the correspondence system 102 may convert data (text, images, or both) into a physical form by printing the data onto paper using at least one of the printers 136. The printed information may then be packaged into an envelope or box by a packaging unit 138 to which postage may be applied in order to send the correspondence to an address associated with an inmate via the United States Postal Service.

The correspondence system 102 may include a network interface 110 configured to communicate with the network 106 and with data sources 108 and computing devices 104 through the network 106. The correspondence system 102 may further include a processor 112 coupled to the network interface 110, to a memory 114, a database of facility correspondence rules 116, and to a production interface 134, which may be coupled to the printers 136 and the packaging units 138. In some embodiments, the database of facility correspondence rules 116 may be stored in the memory 114. In other embodiments, the database of facility correspondence rules 116 may be accessible via the network 106.

In certain embodiments, the database of facility correspondence rules 116 may be updated manually by an administrator associated with the correspondence system 102 or by an administrator associated with the incarceration facility using a computing device 104. The database of facility correspondence rules 116 may be updated based on failed delivery events, based on publicly available information, based on communications with administrators at the incarceration facility, or any combination thereof. In certain embodiments, the processor 112 may be configured to automatically update correspondence rules by checking facility correspondence rules available from websites or other data sources 108 and comparing them against stored information in the facility correspondence rules database 116 to detect changes and to automatically update the rules within the database 116 in response to detecting changes. Alternatively, such detected changes can be reported to an operator of the correspondence system 102 for verifying the changes and to update the rules in the database 116. Other embodiments are also possible.

The memory 102 can include a graphical user interface (GUI) generator 118 that, when executed, may cause the processor 112 to produce a graphical interface including information as well as one or more user-selectable elements accessible by a user (via an interface of a computing device) to provide correspondence for transmission to an inmate. The user may be a friend or family member of an incarcerated person. In some embodiments, the user may access the interface to log in, to upload or write correspondence, to upload images or other documents, to correct compliance issues, and to send the correspondence to a selected inmate. When setting up the account, the user may configure contact information for an inmate by adding the inmate's name and his or her incarceration number. Further, the user may select a facility where he or she is incarcerated from a pull-down menu or may type the address into a field within the interface. Further, the user may add multiple inmates. Once an inmate is selected, the user may draft or upload correspondence address to the user and may attach pictures, documents or other information for transmission to the inmate.

In some embodiments, the user may attempt to use the graphical interface to set up an account. When selecting the incarceration facility where the inmate is being held, in some instances, the particular facility may not yet be included in the list. If this happens, the graphical interface may allow the user to add the name and other details associated with the facility, and the graphical interface may alert the user that the facility address and correspondence rules will need to be verified and added before the system 102 can be used to send correspondence to the inmate. In an example, the correspondence system 102 may send an email or other alert to the user when the facility setup is completed.

The memory 114 may include a data analyzer 120 that, when executed, may cause the processor 112 to process received data into a set of temporary tables. In some embodiments, the processor 112 may analyze the content of the data using semantic analysis as well as optical analysis (of images) to determine one or more attributes associated with the content.

The memory 122 may include an address detector 122 that, when executed, may cause the processor 112 to determine an address from the uploaded content. When the address is selected from a pull-down menu (for example), such detection is not necessary; however, when the address is included within a document (word processor document, scanned image, or other source), the address information may be determined using optical carriage recognition (OCR), pattern recognition, semantic analysis, other address detection rules, or any combination thereof.

The memory 122 can include a rules analyzer 124 that, when executed, may cause the processor 112 to determine one or more correspondence rules from a plurality of correspondence rules in the database 116 that correspond to an address provided for the inmate. In some embodiments, such as where the address for the facility is not already included in the database 124, where the correspondence rules are not included in the database 124, the rules analyzer 124 may cause the processor 112 to determine the correspondence rules from at least one data source 108 (such as a website for the facility or for the detection facility), or any combination thereof. In certain embodiments, the rules analyzer 124 may process the data from the correspondence against the correspondence rules to determine if the correspondence complies with the rules.

The memory 122 can also include an alerting module 126 that, when executed, may cause the processor 112 to send an alert to a user when the correspondence does not comply with the correspondence rules (or to notify the user when a new facility setup is complete). In some embodiments, the alert may include a text message, an email message, a voice message, another electronic message or any combination thereof. The alert may include information identifying the compliance issue, providing recommendations regarding how the user can overcome the compliance issues, requesting authorization from the user to assist in overcoming the compliance issues, or any combination thereof.

The memory 114 can include an adjustment module 128 that, when executed, may cause the processor 112 to automatically adjust at least one at least one attribute of the correspondence. In an example, a compliance rule may include a total number of pages of a correspondence package. In response to the determination that the correspondence is not in compliance with the rule, the adjustment module 128 may cause the processor 112 to automatically determine an adjustment to the correspondence and to apply the adjustment to produce a correspondence package. In an example, the adjustment module 128 may cause the processor to adjust the print margins, the font size, line spacing, or any combination thereof of the text within the correspondence package to reduce the overall page count. In another example, the adjustment module 128 may cause the processor to divide the correspondence into two packages so that each package will fit within the page count limit. In an example where the facility does not allow attachments, the adjustment module 128 may embed the attachment. Other adjustments are also possible.

The memory 114 can include a production module 130 that, when executed, may cause the processor 112 to control one or more of the printers 136 and the packaging units 138 via the production interface 134 to generate at least one printed package that complies with the correspondence rules and that can be shipped (mailed via the United States Postal Service or another package delivery service) to the inmate. In some embodiments, the production module 130 may cause the processor 130 to control one or both of the printer 136 and the packaging unit 138. In some embodiments, the printer 136 may include an output tray that may be configured to automatically deliver the printed correspondence to the packing unit 138, which may include an automated folding unit, an envelope filling unit, or another device for packaging the printed correspondence in a deliverable envelope.

The memory 114 can include a speech-to-text converter 140 that, when executed, may cause the processor 112 to receive audio data and to convert the audio data into text data, which may be delivered to the data analyzer 120 for processing as described above with respect to other input data. Further, the memory 102 may store user data 142 about a subscriber or registered user. The user data 142 may include login data, previous correspondence data, billing information, preferences, inmate information, other data, or any combination thereof.

In some embodiments, the correspondence system 102 may be configured to facilitate correspondence between individuals and inmates. By analyzing correspondence data against correspondence rules, the correspondence system 102 can assist a user by ensuring that the package mailed to the inmate complies with the correspondence rules. Further, in some examples, particular correctional facilities may restrict certain types of photographs. The correspondence system 102 may print the picture using one of the printers 136 to produce a photograph that complies with the facility's rules. Other embodiments are also possible.

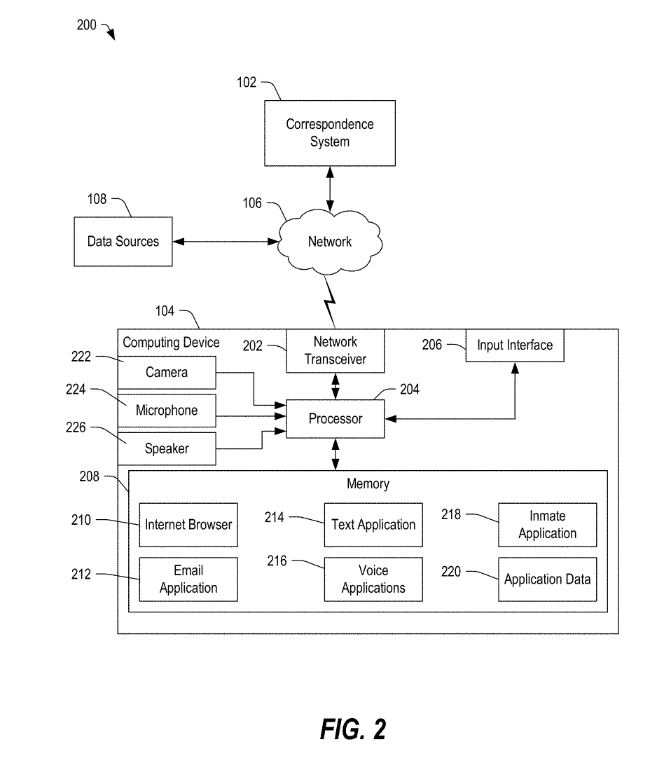

In certain examples, the correspondence system 100 may be implemented as an application that can run on one or more servers as a cloud-based system. In other examples, the correspondence system 100 may include an application running on a computing device 104, such as a smart phone 104B. The application running on the computing device 104 may determine the facility correspondence rules from a data source, such as the database 116 or one of the data sources 108, and may process correspondence data against the correspondence rules, providing recommendations or automatically adjusting the data to produce a correspondence package that can be printed and mailed in compliance with the facility's correspondence rules. Other embodiments are also possible. One possible example of a computing device configured to execute an inmate correspondence application is described below with respect to FIG. 2.

FIG. 2 illustrates a block diagram of an inmate correspondence system 200, in accordance with certain embodiments of the present disclosure. The inmate correspondence system 200 may be an embodiment of the correspondence system 100 of FIG. 1. In this example, the computing device 104 may be a tablet computer, a smartphone, or another computing device.

The computing device 104 may include a network transceiver 202 configured to communicate with the network 106 through a wired or wireless communication link. The computing device 104 can also include a processor 204 coupled to the network transceiver 202. The processor 204 may also be coupled to a memory 208 and to an input interface 206, such as a touchscreen interface configured to display information and to receive input data. In some embodiments, the computing device 104 can include a camera 222 configured to capture images or video. Further, the computing device 104 can include a microphone 224 configured to convert sounds into audio data and a speaker 226 configured to confirm signals into audible sounds. The camera 222, the microphone 224, and the speaker 226 may be coupled to the processor 204.

The memory 208 may include an Internet browser application 210 that, when executed, may cause the processor 204 to provide an Internet browser interface accessible by a user via the input interface 206 to visit web pages. In some embodiments, the user may utilize the computing device 104 to access the correspondence system 102 to upload correspondence and to initiate transmission of the correspondence to an inmate. In a particular example, the correspondence system 102 may provide a graphical interface including information and user-selectable elements, which may be rendered and accessed via the Internet browser application 210 to enable the user to upload and correct correspondence intended for shipment to the inmate.

Further, the memory 208 may include an email application 212 that, when executed, may cause the processor 204 to send and receive electronic mail through the network 106. The memory 208 may also include a text application 214 that, when executed, may cause the processor 204 to send and receive text messages through the network 106. The memory 208 may further include one or more voice applications 216 that, when executed, may cause the processor 204 to provide various functions, including initiating and receiving phone calls, receiving and storing voice mail messages, capturing audio recordings, capturing images or video, other functions, or any combination thereof.

The memory 208 may include an inmate application 218 that, when executed, may cause the processor 204 to receive input data, to determine correspondence rules corresponding to an incarceration facility, to determine compliance of the correspondence to the correspondence rules, to alert the user when the content does not comply with the correspondence rules, and so on. In some embodiments, the inmate application 218 may send a portion of the correspondence data to the correspondence system 102 for analysis and may display information to the user via the input interface 206 in response to data received from the correspondence system 102. In some embodiments, the inmate application 218 may finalize a correspondence packet for mailing and may forward the finalized correspondence packet to the correspondence system 102 for printing and mailing. Alternatively, the inmate application 218 may be configured to communicate with a printer through a direct connection or through the network 106 to print the correspondence package for mailing. Other embodiments are also possible.

The memory 208 may also include application data 220, which may include stored preferences and information associated with the inmate application 218. Further, the application data 220 can include the uploaded information for sending to the inmate and can include completed package information, which allows the user to see what was previously sent. Other embodiments are also possible.

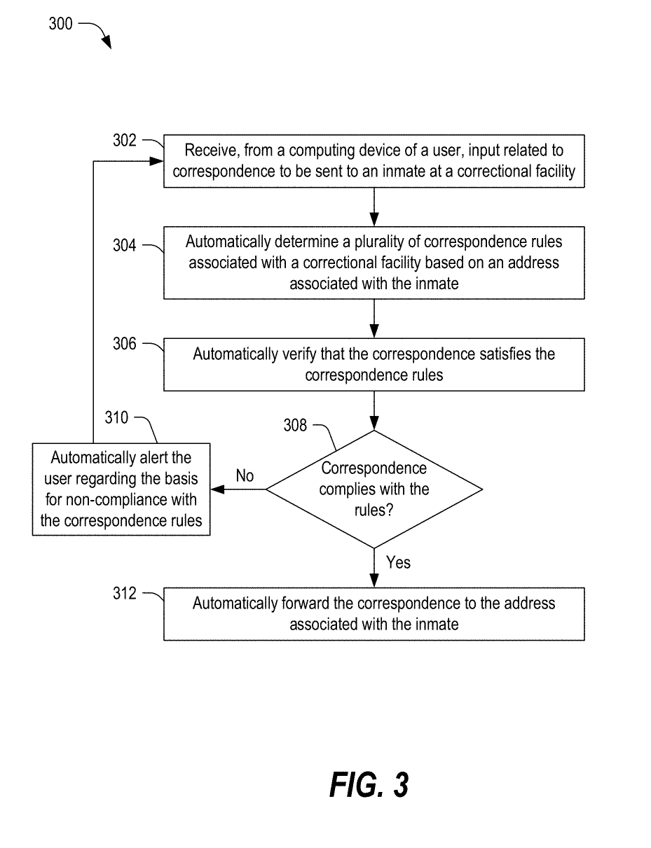

FIG. 3 depicts a flow diagram of a method 300 of producing correspondence addressed to an inmate, in accordance with certain embodiments of the present disclosure. At 302, the method 300 may include receiving, from a computing device of a user, input related to correspondence to be sent to an inmate at a correctional facility. The input may include text, images, audio data, video data, or any combination thereof. The input may further include an identifier associated with an inmate, including an address to which the correspondence is to be sent.

At 304, the method 300 can include automatically determining a plurality of correspondence rules associated with a correctional facility based on an address associated with the inmate. In an example, the correctional facility may include a jail, a prison, a work-release facility, or any combination thereof. The rules may be determined from a database of correspondence rules or may be determined from a web page associated with the correctional facility.

At 306, the method 300 may include automatically verifying that the correspondence satisfies (or complies with) the correspondence rules. The system may automatically verify the compliance of the correspondence by semantically analyzing the content to identify potential issues, by processing the number of pages of the correspondence, by optically analyzing images, or any combination thereof. In some embodiments, if the page count exceeds a page limit imposed by the correspondence rules, the system may determine that the correspondence does not comply. Similarly, image data may be analyzed for human forms and photos that include nudity may be flagged as potentially problematic. In some instances, an operator (such as an administrator) may review such “flagged” images may be reviewed by an employee to verify compliance. In some embodiments, the automatic verification may include performing optical character recognition (OCR) operations on text within an uploaded document and processing the resulting text to determine compliance. Other embodiments are also possible.

At 308, if the correspondence does not comply with the rules, the method 300 may include automatically alerting the user regarding the basis for the non-compliance with the correspondence rules, at 310. The alert may include a text message, an email message, an indicator (text or image) displayed within an application running on the user's computing device, an audio alert played through a speaker of the user's computing device, an audio message, or any combination thereof. The method 300 may then return to 302 to receive, from a computing device of a user, input related to correspondence to be sent to an inmate at a correctional facility.

Otherwise, at 308, if the correspondence complies with the rules, the method 300 can include automatically forwarding the correspondence to the address associated with the inmate, at 312. In an example, the correspondence may be printed, packaged, and mailed via the United States Postal Service or another authorized mail carrier. In another example, the correspondence may be emailed to a computing device associated with the correctional facility for printing or viewing on-site. Other embodiments are also possible.

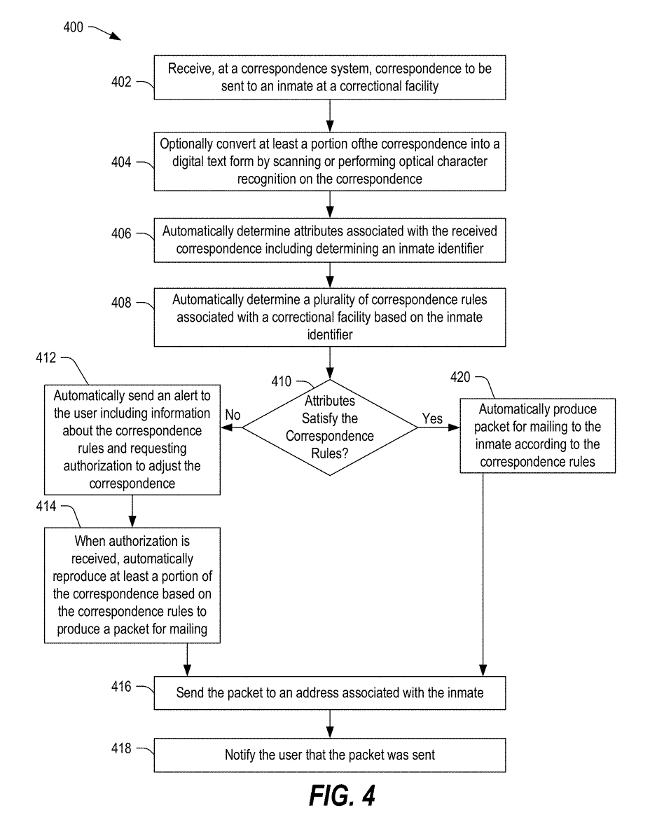

In some embodiments, depending on the basis for non-compliance, the computing system may be configured to selectively alter at least a portion of the correspondence data to enable compliance with the rules. One possible example of a method of selectively altering a portion of the correspondence data is described below with respect to FIG. 4.

FIG. 4 depicts a flow diagram of a method 400 of processing a package to produce correspondence addressed to an inmate, in accordance with certain embodiments of the present disclosure. At 402, the method 400 may include receiving, at a correspondence system, correspondence to be sent to an inmate at a correctional facility. The correspondence may include text, images, audio, or any combination thereof.

At 404, the method 400 may include optionally converting at least a portion of the correspondence into a digital text form by scanning or performing optical character recognition on the correspondence. In some embodiments, a faxed or scanned document may be processed using optical character recognition operations to extract text data from the image. Further, a speech-to-text application may be used to extract text from an audio file, which extracted text may then be further processed.

At 406, the method 400 can include automatically determining attributes associated with the received correspondence including determining an inmate identifier. In some embodiments, the inmate identifier may include the inmate's name, the inmate's identification number, and the mailing address of the facility at which the inmate is incarcerated.

At 408, the method 400 may include automatically determining a plurality of correspondence rules associated with a correctional facility based on the inmate identifier. In an example, the system may look up the correspondence rules for a particular facility based on the inmate's address.

At 410, if the attributes of the correspondence do not satisfy (comply with) the correspondence rules, the method 400 may include automatically sending an alert to the user including information about the correspondence rules and requesting authorization to adjust the correspondence, at 412. At 414, the method 400 may include, when authorization is received (or in response to receiving authorization), automatically reproducing at least a portion of the correspondence based on the correspondence rules to produce a packet for mailing. In an example, if the correspondence exceeds a page count, the system may reproduce a portion of the correspondence within the page limit and then may produce a second portion of the correspondence within the page limit for two separate packets for mailing. In other examples, the reproduction may include adjusted margins, adjusted fonts, or other adjustments to satisfy various correspondence rules.

The method 400 can further include sending the packet to an address associated with the inmate, at 416. The packet may be sent by United States Postal Service or another authorized delivery service. Alternatively, the packet may be sent in a digital form. Further, the method 400 can include notifying the user that the packet was sent, at 418. In some instances, delivery may also be confirmed (at a later time).

Returning to 410, if the attributes do not satisfy (comply) with the correspondence rules, the method 400 may include automatically producing the packet for mailing to the inmate according to the correspondence rules, at 420. The method 400 can further include sending the packet to an address associated with the inmate, at 416. Further, the method 400 can include notifying the user that the packet was sent, at 418.

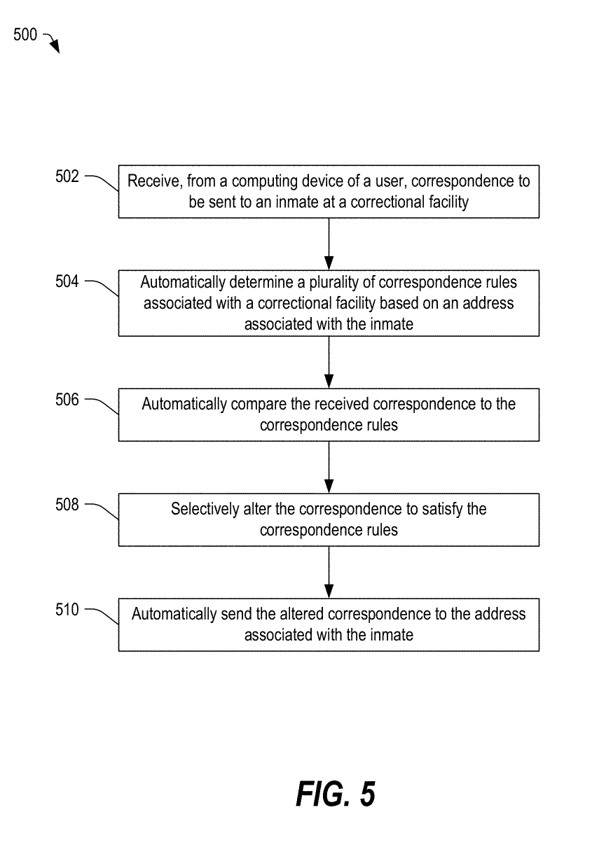

FIG. 5 depicts a flow diagram of a method 500 of selectively adjusting correspondence addressed to an inmate to comply with rules of an incarceration facility, in accordance with certain embodiments of the present disclosure. At 502, the method 500 can include receiving, from a computing device of a user, correspondence to be sent to an inmate at a correctional facility. The correspondence may include text, images, audio, or any combination thereof. The images may include scanned documents.

At 504, the method 500 can include determining a plurality of correspondence rules associated with a correctional facility based on an address associated with the inmate. The system may determine the correspondence rules by automatically searching a website associated with the correctional facility or by searching a database of such rules.

At 506, the method 500 may include automatically comparing the received correspondence to the correspondence rules. In a particular example, the system may determine if the content complies with the correspondence rules, in terms of semantic content, image content, number of pages, and so on.

At 508, the method 500 can include selectively altering the correspondence to satisfy the correspondence rules. Such selective alteration can include adjusting margins, reducing font sizes, or even dividing the correspondence into two or more packages.

At 510, the method 500 can include automatically sending the altered correspondence to the address associated with the inmate. Such automatic sending may include packaging the correspondence into one or more envelopes, printing labels for or onto the envelopes, applying postage to the envelopes, sealing the envelopes, and placing the envelopes into a mailbox or mail bin for pickup. Other embodiments are also possible.

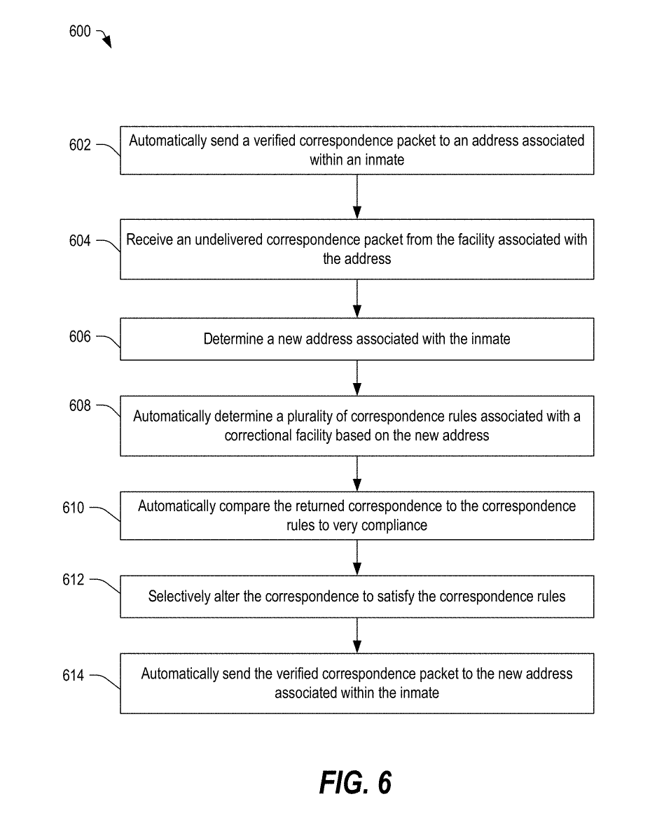

In some instances, the correspondence address for an inmate may change on short notice, and the correspondence packet may be returned. One possible method for handling returned mail is described below with respect to FIG. 6.

FIG. 6 illustrates a flow diagram of a method 600 of forwarding returned correspondence to a new address associated with the inmate, in accordance with certain embodiments of the present disclosure. At 602, the method 600 can include automatically sending a verified correspondence packet to an address associated with an inmate. The correspondence packet may be verified by comparing the correspondence to a set of correspondence rules associated with the address of the inmate.

At 604, the method 600 may include receiving an undelivered correspondence packet from the facility associated with the address. In response to receiving the undelivered packet, the method 600 can include determining a new address associated with the inmate, at 606. The new address may be determined by communicating with the sender of the packet to acquire the new address, by communicating with the facility to determine the new address, or by another means.

At 608, the method 600 may include automatically determining a plurality of correspondence rules associated with a correctional facility based on the new address. The method 600 may further include automatically comparing the returned correspondence to the correspondence rules to verify compliance, at 610. At 612, the method 600 can include selectively altering the correspondence to satisfy the correspondence rules. If the returned correspondence complies with the rules, then the packet can be sent to the new address without alteration.

At 614, the method 600 may include automatically sending the verified correspondence packet to the new address associated with the inmate. The method 600 may also include sending an alert to the original sender to explain the return and to verify resending of the packet to the new address. Other embodiments are also possible.

In the embodiments of FIGS. 3-6, the steps of the various methods are provided for illustrative purposes only. It should be appreciated that steps may be combined or other steps added without departing from the scope of the present disclosure. Further, the methods of FIGS. 3-6 are not mutually exclusive, and the various methods or selected steps from the various methods may be combined into a single flow without departing from the scope of the present disclosure.

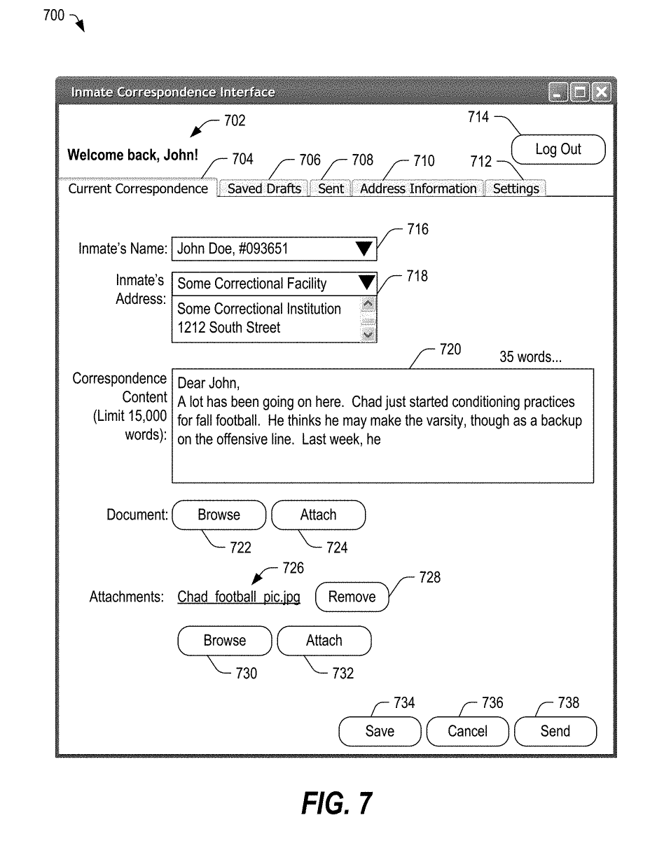

FIG. 7 depicts an interface 700 through which a user may interact with the inmate correspondence system to send correspondence to a selected inmate, in accordance with certain embodiments of the present disclosure. The interface 700 may include an acknowledgement panel 702, which may acknowledge the user by name and which may include a log out button or link 704. The interface 700 may also include a plurality of tabs, which may be selected by a user to access various items of information. The tabs can include a first tab 704 (labeled “Current Correspondence”), a second tab 706 (labeled “Saved Drafts”), a third tab 708 (labeled “Sent”), a fourth tab 710 (labeled “Address Information”), and a fifth tab 712 (labeled “Settings”). Other tabs may also be provided. A user may access the Saved Drafts tab 706 to access a list of draft correspondence that has not yet been submitted. The user may access the Sent tab 708 to view previously sent correspondence (and optionally to track delivery). The user may access the “Address Information” tab 710 to view and optionally edit the user-configured address information for a particular inmate. The user may also access the Settings tab 712 to configure automatic settings, enabling the system to automatically adjust correspondence to comply with the correspondence rules. In the illustrated example, the Current Correspondence tab 704 is selected.

The interface 700 may include a pull-down menu 716 that may be accessed by a user to select an inmate from a list of inmates. The pull-down menu 716 may include only one inmate and may provide a selectable option to add another name. Selection of the “add” option may allow a user to add an inmate and to select or add a corresponding mailing address.

The interface 700 may also include a pull-down menu 718 through which the user may select an address from a list or change the current address, which may be displayed in response to selection of a particular inmate.

The interface 700 may further include a text field 720 that may allow the user to type or copy and paste text, such as the text of a letter. Alternatively, the user may type the letter directly into the text field. The interface 700 may also include a browse button 722 and an attach button 724 that may be accessed by the user to attach a text document from which text data may be extracted and added to the text field 720. The interface 700 can also include an uploaded image 726 (labeled “Chad_Football_Pic.jpg”) with an associated Remove button 728. Further, the interface 700 may include a browse button 730 and an attach button 732 for selecting and uploading additional images.

The interface 700 may also include a Save button 734 for saving a draft of the message for editing at a later time. The interface 700 can also include a “Cancel” button 736 accessible by a user to discard the current draft. The interface 700 can also include a “Send” button 738 that, when selected, may cause the interface 700 to forward the data to the correspondence system for production as a package and for shipping of the package to the identified inmate at the selected address.

It should be understood that the interface 700 is an illustrative example of an interface that may be displayed within an Internet browser application or within a standalone application executing on a computing device. However, other interfaces may also be used and the arrangement and content of the interface may vary according to the particular implementation.

In conjunction with the systems, methods and interfaces described above with respect to FIGS. 1-7, a system may be configured to facilitate postal communications between a user and an inmate within a jail or prison. The system may be configured to verify that the correspondence complies with the particular correspondence rules of the facility where the inmate is incarcerated. If the correspondence does not comply, the system may generate an alert to the user to fix the issue. Alternatively, the system may automatically adjust the correspondence to comply with the correspondence rules. Other embodiments are also possible.

The processes, machines, and manufactures (and improvements thereof) described herein are particularly useful improvements for inmate communication systems. Further, the embodiments and examples herein provide improvements in the technology of generating correspondence packets for mailing to inmates. In addition, embodiments and examples herein provide improvements to the functioning of a computer by providing correspondence evaluation functions that compare correspondence data to correspondence rules for a particular facility to ensure delivery of the correspondence, thereby creating a specific purpose computer by adding such technology. Thus, the improvements herein provide for technical advantages, such as providing a system in which a user's interaction with a computer system make inmate correspondence easier and more reliable by verifying the correspondence against the correspondence rules for the particular facility to ensure that correspondence sent to the inmate complies with the rules for that particular facility. For example, the systems and processes described herein can be particularly useful to any family member wishing to send correspondence, pictures, and other items to inmates. Further, the improvements herein provide additional technical advantages, such as providing a system in which non-compliant correspondence can be fixed automatically on behalf of the sender prior to mailing to the inmate. While technical fields, descriptions, improvements, and advantages are discussed herein, these are not exhaustive and the embodiments and examples provided herein can apply to other technical fields, can provide further technical advantages, can provide for improvements to other technologies, and can provide other benefits to technology. Further, each of the embodiments and examples may include any one or more improvements, benefits and advantages presented herein.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, in the flow diagrams presented herein, in certain embodiments, blocks may be removed or combined without departing from the scope of the disclosure. Further, structural and functional elements within the diagram may be combined, in certain embodiments, without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A system comprises:
an interface configured to communicate with a network to receive correspondence data for an inmate of an incarceration facility from a computing device;
a processor coupled to the interface and configured to:
determine correspondence rules corresponding to the incarceration facility from a plurality of correspondence rules based on an address associated with the inmate;
verify the correspondence data against the correspondence rules; and
selectively adjust the correspondence data to comply with the correspondence rules before preparing a packet for mailing to the inmate.

2. The system of claim 1, further comprising a production interface coupled to the processor and configured to control at least one of a printer and a packaging unit to produce the packet for mailing to the inmate.

3. The system of claim 1, wherein the correspondence data includes at least one of text data, audio data, and image data.

4. The system of claim 4, wherein the memory further stores instructions that, when executed, cause the processor to:
provide a graphical interface to receive data related to a new facility;
receive the data related to the new facility;
automatically search one or more data sources to verify the data related to the new facility; and
automatically send an alert to the computing device after verifying the data.

5. The system of claim 1, wherein the processor is configured to verify the correspondence data by determining a number of pages of the correspondence data is not greater than a threshold number of pages of the correspondence rules.

6. The system of claim 5, wherein the processor is configured to automatically adjust at least one of a page margin parameter, a font parameter, and a line spacing parameter of the correspondence data to reduce the number of pages to comply with the correspondence rules.

7. The system of claim 1, wherein the processor is configured to send an alert to the computing device when at least one parameter of the correspondence data does not comply with the correspondence rules.

8. A computing device comprising:
a network interface configured to communicate with a network;
a processor coupled to the network interface;
a printer coupled to the processor; and
a memory coupled to the processor and configured to store instructions that, when executed, cause the processor to:
receive correspondence data from a computing device through the network;
determine correspondence rules corresponding to the incarceration facility from a plurality of correspondence rules based on an address associated with the correspondence data;
process the correspondence data to determine compliance with the correspondence rules; and
control the printer to produce a physical copy of the correspondence data for mailing to an inmate of a correctional facility when the correspondence data complies with the correspondence rules associated with the address.

9. The computing device of claim 8, wherein the memory further includes instructions that, when executed, cause the processor to automatically adjust at least one of a page margin, a font size, and a line spacing parameter of the correspondence data when a page count exceeds a maximum page count of the correspondence rules.

10. The computing device of claim 8, wherein the memory further includes instructions that, when executed, cause the processor to:
detect a photograph within the correspondence data; and
process the photograph to determine compliance with the compliance rules; and
send an alert to the computing device when the photograph is not in compliance, the alert including instructions explaining the non-compliance.

11. The computing device of claim 8, wherein the correspondence data includes at least one of text data, audio data, and image data.

12. The computing device of claim 11, wherein the memory further includes instructions that, when executed, cause the processor to:
provide a graphical interface to receive data related to a new facility;
receive the data related to the new facility;
automatically search one or more data sources to verify the data related to the new facility; and
automatically send an alert to the computing device after verifying the data.

13. The computing device of claim 8, wherein the processor is configured to verify the correspondence data by determining a number of pages of the correspondence data is not greater than a threshold number of pages of the correspondence rules.

14. A method comprising:
receiving, at a computing device, correspondence data for sending to an inmate of a correctional facility;
automatically determining, at the computing device, correspondence rules associated with the correctional facility from a database including a plurality of compliance rules;
automatically processing, at the computing device, the correspondence data to determine compliance with the correspondence rules; and
automatically providing the correspondence data to a printing device to produce a physical copy of the correspondence data when the correspondence data complies.

15. The method of claim 14, further comprising sending an alert to a display of the computing device when the correspondence data does not comply with the correspondence rules.

16. The method of claim 14, further comprising sending an alert from the computing device to a device through a network when the correspondence data does not comply with the correspondence rules.

17. The method of claim 14, further comprising:
automatically determining a number of pages of the correspondence data;
selectively adjusting page margins of the correspondence data to reduce the number of pages when the number of pages is greater than a threshold number of pages in the correspondence rules; and
automatically providing the correspondence data with the adjusted number of pages to the printing device to produce the physical copy.

18. The method of claim 14, further comprising:
automatically determining a number of pages of the correspondence data;
selectively adjusting at least one of a font parameter and a line spacing parameter of the correspondence data to reduce the number of pages to comply with the correspondence rules when the number of pages is greater than a threshold number of pages in the correspondence rules; and
automatically providing the correspondence data with the adjusted number of pages to the printing device to produce the physical copy.

19. The method of claim 14, further comprising:
providing a graphical interface to receive data related to a new facility;
receiving the data related to the new facility;
automatically searching one or more data sources to verify the data related to the new facility; and
automatically sending an alert to a computing device through a network after verifying the data.

20. The method of claim 14, wherein the correspondence data includes at least one of text data, audio data, and image data.
